(19) United States
(12) Patent Application Publication
(10) Pub. No.: US 2006/0108929 A1
(43) Pub. Date: May 25, 2006

(54) Electric lamp having an outer bulb

(75) Inventors: Thomas Bittmann, Friedberg (DE); Thomas Deutscher, Nennslingen (DE); Jurgen Graf, Augsburg (DE); Richard Semba, Augsburg (DE); Marcel Vuc, Neuburg (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/281,433

(22) Filed: Nov. 18, 2005

(30) Foreign Application Priority Data
Nov. 23, 2004 (DE) 1020044056452.3

(51) Int. Cl. H01J 61/30; H01J 17/16

(52) U.S. Cl. 313/634

(57) ABSTRACT

The elongate bulb (1) of the lamp, which defines a longitudinal axis (A), is sealed at mutually opposing ends by sealing parts (6; 32), on which an outer bulb is fixed by means of a beading. The end of a tube piece adjoining the outer bulb is attached to the beading tangentially on the inside.

### TECHNICAL FIELD

The invention relates to an electric lamp having an outer bulb in accordance with the precharacterizing clause of claim 1. Of concern here are, in particular, metal halide lamps, mercury high-pressure discharge lamps, but also halogen incandescent lamps having an outer bulb. The inner bulb of the lamp is sealed at two ends using sealing parts. The outer bulb is fixed to one or both of the sealing parts.

### PRIOR ART

EP-A 465 083 and EP-A 588 602 have already disclosed an electric lamp having an outer bulb, this lamp having a burner, which is surrounded by an outer bulb fixed to the sealing part. For a better connection, in this case in particular a radial beading is provided on the sealing part, the end of the outer bulb resting on said radial beading and being fused with the beading there.

On the other hand, it is known, for example, from WO 95/32516 to roll an outer bulb directly onto the sealing part without any beading.

U.S. Pat. No. 6,790,115 has disclosed a generic lamp, in the case of which an extension of the seal of the discharge vessel is “scratched” on one side, and the outer bulb is fixed thereto.

One disadvantage of these connection techniques is the fact that the robustness achieved of the connection between the outer bulb and the sealing part in any case leaves something to be desired. Without the beading, a time-consuming tempering process is also needed for this purpose.

### SUMMARY OF THE INVENTION

One object of the present invention is to provide a lamp in accordance with the precharacterizing clause of claim 1 which ensures a reliable connection, which can be subjected to a load, between the outer bulb and the sealing part of the inner bulb.

This object is achieved by the characterizing features of claim 1. Particularly advantageous refinements are described in the dependent claims.

The lamp according to the invention has an inner bulb, which is sealed in a vacuum-tight manner, in particular a discharge vessel, which defines a lamp axis and is sealed at mutually opposing ends by sealing parts. The sealing part is a pinch seal or else a fuse seal. The luminous means in the interior of the lamp is a discharge arc between two electrodes or a luminous element. It is electrically conductively connected to the internal power supply lines leading to it. The sealing part is in particular provided with an outwardly protruding extension, which is in the form of a hollow tube.

At least one sealing part is provided having an in particular annular beading, which protrudes radially transversely with respect to the lamp axis. The beading is essentially convex in cross section, i.e. the beading forms a maximum height H on the sealing part or its extension, having an apex with a pronounced radius of curvature, which lies predominantly in the beading. The beading either does not have a point of inflection and thus has a purely convex curvature, for example following a parabola, which is provided with a pronounced apex, or else the beading has a point of inflection, which is, however, at most at a height Hw of 0.25 H, based on the maximum height H of the apex of the beading. Such a design of the beading can be produced after local heating either by compression or blowing. An even simpler method is the application of a correspondingly shaped glass bead.

Critically, the shaping makes it easier for the outer bulb to rest essentially axially on the inner side of the beading in the vicinity of the apex. In order to ensure this, the inner diameter of the end of the outer bulb is selected to be smaller than the outer diameter of the beading. The outer diameter of the end of the outer bulb is preferably approximately the same size as the outer diameter at the apex of the beading. It may also be slightly larger, in particular by up to 30%.

The outer bulb may be a continuous tube piece having a constant diameter, but also a bulb having a central bulge and tube pieces adjoining said central bulge at the ends, in particular attached to it or formed integrally with it.

One preferred embodiment provides a tubular extension piece of the sealing part, adjoined by the beading. In particular, it is attached to it or formed integrally with it. This makes the provision of a radially symmetrical beading possible, even in the case of a pinch seal which is not radially symmetrical. In the case of a fuse seal, such an extension piece is not absolutely necessary. Both the inner bulb and the outer bulb are preferably made from silica glass or hard glass.

In particular, the beading may be designed to be relatively small, the outer diameter of the beading typically being 25 to 80% larger than the diameter, lying therebeneath, of the sealing part. A typical value for the diameter of the sealing part or its extension is 7 mm, and an associated typical value for the outer diameter of the beading is 2 to 4 mm.

In one particular embodiment, a beading is preferred which is hollow such that its maximum inner diameter is larger than the outer diameter of the surrounding sealing part. A concave design of the beading is thus created which is particularly well suited for the end of the outer bulb to nestle against axially.

In the case of the conventional design of the beading, as is previously known, the outer bulb can only be attached axially with difficulty anyway since the contact zone is only very short. Disregarding this, the outer bulb in the prior art always bears against the apex of the beading completely on the outside.

The axial attachment of the outer bulb to the beading improves the strength of the transition to a quite considerable extent, in particular by up to 50%. Stress rings no longer form.

The beading may be produced from the sealing part, for example by compression, or else attached thereto as a separate bead. The breaking strength of the connection between the outer bulb and the beading in this case increases the more intimate the contact between the two.

### BRIEF DESCRIPTION OF THE DRAWINGS

The invention will be explained in more detail below with reference to a plurality of exemplary embodiments. In the drawing:

FIG. 1 shows a side view of a halogen incandescent lamp;

FIG. 2 shows a side view of an exemplary embodiment of a metal halide lamp;

FIG. 3 shows the basic parameters of a first embodiment of a beading;

FIG. 4 shows the basic parameters of a second embodiment of a beading;

FIG. 5 shows a section of a detail of the connection between a solid beading and the outer bulb; and

FIG. 6 shows a section of a detail of the connection between a hollow beading and the outer bulb.

### PREFERRED EMBODIMENT OF THE INVENTION

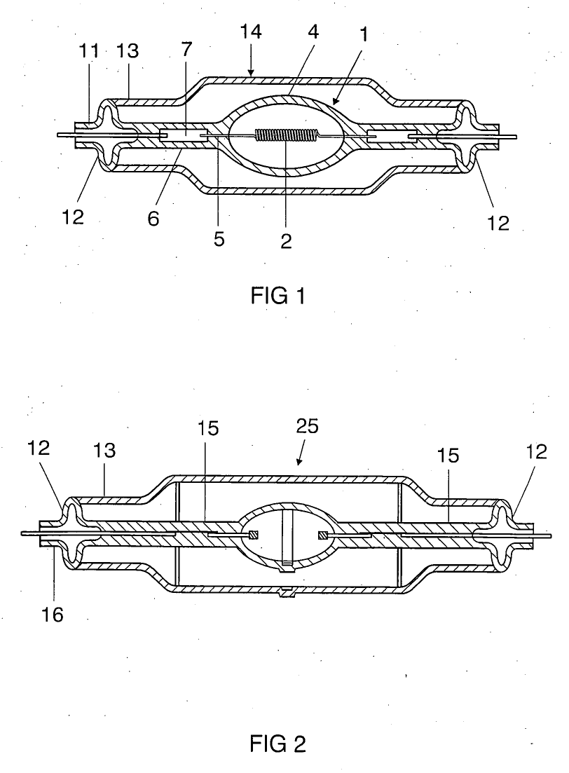

FIG. 1 shows the side view of a halogen incandescent lamp with a pinch seal at two ends. It comprises an inner bulb 1, in whose central part 4 a luminous element 2 is axially arranged.

The ends 5 of the luminous element, in their function as an internal power supply line, are embedded directly in the pinch seal 6 and are connected there to a pinch film 7.

The pinch seal 6 has on the outside, as an extension part, which may also act as a base part, a tubular glass sleeve 11, which is integrally formed on the pinch seal and has an outer diameter of 7 mm and an inner diameter of 5 mm. The sleeve 11 is approximately 7 mm long.

A beading 12, which is essentially convex, is attached to the sleeve 11 on the outside, transversely with respect to the lamp axis. The end of an outer bulb 14, which end is in the form of a tube piece 13, is attached to said beading 12, with the result that the outer bulb extends between the two beadings 12 on both sides of the central part 4.

In addition, a base may be fitted to one end of the sealing part, as is known per se, the base having an electrical contact element (not illustrated), which is electrically conductively connected to a power supply line leading to a luminous means, the contact element being accommodated in the tubular extension of the sealing part.

FIG. 2 shows a metal halide lamp 25 which is sealed by fuse seals 15. In this case, the beadings 12, at which the tube piece 13 ends, are integrally formed with the extension part 16, since in this case the least amount of material needs to be deformed.

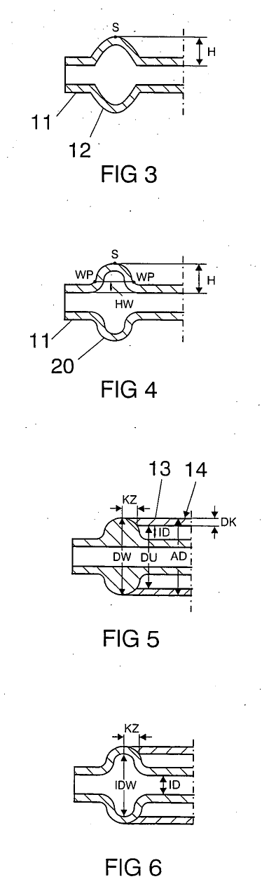

FIG. 3 shows an example of the shape of the beading 12 in cross section. Its design is convex, for example parabolic. The apex S defines the height H of the beading above the level of the support, i.e. the sealing part 11. The curvature is continuously convex. As an alternative, FIG. 4 shows a beading 20 which is essentially convexly curved in cross section but has a widened foot for the purpose of providing better adhesion to the sealing part. The foot points are in this case concavely curved over a short distance, the point of inflection WP lying at most at a height Hw of 25% of the height H of the apex S above the level of the sealing part 11. In this case, the radius of curvature is preferably at its smallest at the apex S, compared with any other point in the convex region.

FIG. 5 shows a section of the lamp which shows an enlarged illustration of a solid beading 12, which can be attached as a glass bead. The outer diameter DW of the beading (measured from apex to apex) is markedly larger than the inner diameter DU of the tubular end 13 of the outer bulb 14. The difference is typically from 1 to 3 mm. The wall thickness of the end 13 having the thickness DK should in general be approximately from 2 to 4 mm. The outer diameter AD of the tubular end 13, on the other hand, is approximately equal to or typically up to 0.5 mm larger or smaller than the maximum outer diameter DW of the beading 12. This arrangement provides as long a contact zone KZ as possible between the end 13 and the beading 12.

In practice, it has been shown that a contact zone, which is as large as possible, primarily as long as possible in the axial direction, in the axial direction between the beading 12 and the outer bulb 14 improves the strength of the connection enormously, up to 50%. For this reason, a convex beading, as shown in FIGS. 3 and 4, is particularly advantageous since, with such a beading 20, the axial length KZ of the contact zone is markedly greater than in the case of the conventional, predominantly concave shape of the beading. A characterizing feature of such a convex beading in the case of a hollow beading 20 is in particular the fact that the inner diameter IDW of the beading is markedly larger than the inner diameter ID of the sealing part surrounding it. Decisive for operation, however, is the outer design explained above. Of secondary importance is whether the beading is solid or hollow.

The axial length KZ should preferably be at least from 2 to 4 mm long. The outer bulb 14 is always in the inner half of the beading pointing towards the discharge, to be precise if possible at the upper edge where there is the least the degree of curvature and therefore the contact zone is at its largest. Ideally, the tube piece is such that the end of the tube piece is attached approximately tangentially to the inside of the beading at the apex, since the axial length KZ is in this case at its longest.

In a similar manner to as is shown in principle in FIG. 1 in U.S. Pat. No. 6,790,115, the novel shape of the beading can also only be used at one end for the purpose of fixing the outer bulb.

1. An electric lamp having an outer bulb having an elongate inner bulb (1), which is sealed in a vacuum-tight manner, defines a longitudinal axis (A), contains a luminous means and is sealed at mutually opposing ends by sealing parts (6; 32), an outer bulb being placed with at least one end tube piece (13) over the inner bulb, and the tube piece (13) being fixed to the sealing part by means of an annular beading (12) located there, characterized in that the beading is essentially convex in cross section having an apex (S), the tube piece being attached to that side of the beading which faces the luminous means in the vicinity of the apex.

2. The lamp as claimed in claim 1, characterized in that the maximum diameter DW of the beading is larger than the inner diameter ID of the tube piece.

3. The lamp as claimed in claim 2, characterized in that the outer diameter AD of the tube piece approximately corresponds to the maximum diameter of the beading.

4. The lamp as claimed in claim 3, characterized in that the overlap is at least 50% of the wall thickness of the tube piece.

5. The lamp as claimed in claim 3, characterized in that the two values differ from one another by at most 1.5 mm.

6. The lamp as claimed in claim 1, characterized in that the beading (12) rests on a tubular extension of the sealing part.

7. The lamp as claimed in claim 1, characterized in that the sealing part is a fuse seal, the beading resting in particular directly on the fuse seal.

8. The lamp as claimed in claim 1, characterized in that the sealing part is a pinch seal, a tubular extension being attached on the outside to said pinch seal, and the beading resting in particular directly on the extension.

9. The lamp as claimed in claim 8, characterized in that the beading is hollow and has an inner diameter IDW, which is larger than the inner diameter ID of the extension.

10. The lamp as claimed in claim 1, characterized in that the beading is completely convex or is convex to such an extent that any point of inflection is at a height of a maximum of 20% of the height of the apex.

11. The lamp as claimed in claim 1, characterized in that the end of the tube piece is attached approximately tangentially to the inside of the beading at the apex.

12. The lamp as claimed in claim 1, characterized in that the beading is formed from a separate glass bead.
